(19) United States
(12) Patent Application Publication
(10) Pub. No.: US 2018/0276800 A1
(43) Pub. Date: Sep. 27, 2018

(54) APPARATUS AND METHODS FOR SOURCE DYNAMIC RANGE PROCESSING OF PANORAMIC CONTENT

(71) Applicant: GoPro, Inc., San Mateo, CA (US)

(72) Inventors: Adeel Abbas, Carlsbad, CA (US); David Newman, San Diego, CA (US)

(21) Appl. No.: 15/467,730

(22) Filed: Mar. 23, 2017

(51) Int. Cl. G06T 5/00; H04N 5/232; G09G 5/00

(52) U.S. Cl. CPC G06T 5/009; H04N 5/23238; G09G 2320/066; G06T 2207/20208; G06T 2207/20221; G09G 5/005

(57) ABSTRACT

Apparatus and methods for source dynamic range processing of panoramic and/or spherical imaging content. In one exemplary embodiment, apparatus and methods are disclosed in which capturing the aforementioned panoramic and/or spherical imaging content in a source dynamic range, receiving a viewport position for the panoramic and/or spherical imaging content, stitching (if necessary) the panoramic and/or spherical imaging content in the source dynamic range, and rendering the viewport in the source dynamic range. In a variant, the viewport in the source dynamic range is developed into a display dynamic range, encoded in the display dynamic range and shared with a viewer of the viewport. In another variant, the rendered viewport in the source dynamic range is encoded in the source dynamic range, transmitted and decoded in the source dynamic range and rendered in the display dynamic range.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the disclosure

The present disclosure relates generally to source dynamic range processing of image and/or video content, and more particularly in one exemplary aspect to the rendering of viewports within a captured panoramic image.

### Description of Related Art

So-called “virtual reality” (VR) (and its mixed reality progeny; e.g., augmented reality, augmented virtuality, etc.) is a computer technology that seeks to create an artificial environment for user interaction. Current prototypes render panoramic video, audio, and/or tactile content through a display (e.g., a viewport) consistent with the user's movement. For example, when a user tilts or turns their head, the image is also tilted or turned proportionately (audio and/or tactile feedback may also be adjusted). When effectively used, VR and VR-like content can create an illusion of immersion within an artificial world. Additionally, since the viewer is not physically constrained by the human body, the VR experience can enable interactions that would otherwise be difficult, hazardous, and/or physically impossible to do. VR has a number of interesting applications, including without limitation: gaming applications, medical applications, industrial applications, space/aeronautics applications, and geophysical exploration applications.

Existing VR solutions do not currently take full advantage of the image capturing capabilities of panoramic camera systems such as those described below with reference to FIGS. 1A and 1B discussed infra. Specifically, extant implementations capture images in a source dynamic range, develop the source dynamic range content into a display dynamic range where it is processed (e.g., stitch, render, encode, and transmit), all in a display dynamic range. Such implementations are suboptimal as developing the source dynamic range image into a display dynamic range image often results in displayed images that do not optimally preserve the details in, for example, highlights and shadows of the captured image.

### SUMMARY

The present disclosure satisfies the foregoing needs by providing, inter alfa, methods and apparatus for source dynamic range image processing techniques for, for example, panoramic and/or spherical images.

In a first aspect, a method for the display of imaging content is disclosed. In one embodiment, the method includes obtaining two or more images in a source dynamic range; receiving a viewport position for a viewer of at least a portion of the obtained two or more images; determining whether the viewport position is resident on a stitching line, and if so, stitching at least a portion of the two or more images in the received viewport position; rendering the viewport position in the source dynamic range in order to produce a rendered source dynamic range image for the viewport position; developing the rendered source dynamic range image into a display dynamic range image for the viewport position; encoding the display dynamic range image for the viewport position in a display dynamic range; and transmitting the encoded display dynamic range image for the purpose of a display of the viewport position in the display dynamic range.

In one variant, the rendering of the viewport position in the source dynamic range is performed by utilizing a viewport dynamic range associated with the received viewport position without taking into consideration a full dynamic range associated with the two or more images.

In another variant, if it is determined that the received viewport position is not resident on the stitching line, obviating a stitching process for the transmitted encoded display dynamic range image.

In yet another variant, the method further includes receiving an updated viewport position for the viewer; rendering the updated viewport position in the source dynamic range in order to produce an updated rendered source dynamic range image for the updated viewport position; and developing the updated rendered source dynamic range image for the updated viewport position into an updated display dynamic range image for the updated viewport position.

In yet another variant, the method further includes determining whether the updated viewport position is resident on a stitching line, and if so, utilizing a stitching process for the updated viewport position.

In yet another variant, the stitching process is utilized only for the updated viewport position.

In yet another variant, the updated display dynamic range image for the updated viewport position is produced by utilizing the obtained two or more images in the source dynamic range.

In yet another variant, the updated display dynamic range image for the updated viewport position is produced by utilizing two or more other images in the source dynamic range.

In a second aspect, a method for the rendering of a panoramic image in a source dynamic range is disclosed. In one embodiment, the method includes obtaining two or more images in a source dynamic range; stitching the obtained images in the source dynamic range; and rendering the panoramic image in the source dynamic range.

In one variant, the rendered panoramic image may be stored for later retrieval/transmission of the rendered panoramic image.

In another variant, the rendered panoramic image may be transmitted for subsequent development/rendering in a display dynamic range prior to display.

In a third aspect, a method for the display of a viewport in a display dynamic range is disclosed. In one embodiment, the method includes obtaining panoramic content in a source dynamic range; receiving a viewport position for a viewer of the obtained images; rendering the viewport in the source dynamic range; develop/encode the viewport in a display dynamic range; and displaying the viewport in the display dynamic range.

In a fourth aspect, a computer readable apparatus having a storage medium that is configured to store a computer program having computer-executable instructions, the computer-executable instructions being configured to, when executed implement the aforementioned methodologies is disclosed. In one embodiment, the computer-executable instructions are configured to, when executed: receive two or more images in a source dynamic range; receive a viewport position for a viewer of at least a portion of the received two or more images; and render the viewport position in the source dynamic range in order to produce a rendered source dynamic range image for the viewport position.

In one variant, the computer-executable instructions are further configured to when executed: determine whether the viewport position is resident on a stitching line, and if so, stitch at least a portion of the two or more images in the received viewport position.

In another variant, the computer-executable instructions are further configured to when executed: determine whether the viewport position is resident on a stitching line, and if not, obviate a stitching process for at least a portion of the two or more images in the received viewport position.

In yet another variant, the computer-executable instructions are further configured to when executed: develop the rendered source dynamic range image into a display dynamic range image for the viewport position; encode the display dynamic range image for the viewport position; and transmit the encoded display dynamic range image for the purpose of a display of the viewport position in the display dynamic range.

In yet another variant, the computer-executable instructions are further configured to when executed: encode the rendered source dynamic range image for the viewport position; and transmit the encoded rendered source dynamic range image for the viewport position.

In yet another variant, the transmitted encoded source dynamic range image for the viewport position is configured to be decoded by a computerized apparatus and developed into a display dynamic range image for display.

In another embodiment, the computer-executable instructions are configured to, when executed: obtain two or more images in a source dynamic range; stitch the obtained images in the source dynamic range; and render the panoramic image in the source dynamic range.

In yet another embodiment, the computer-executable instructions are configured to, when executed: obtain panoramic content in a source dynamic range; receive a viewport position for a viewer of the obtained images; render the viewport in the source dynamic range; develop/encode the viewport in a display dynamic range; and display the viewport in the display dynamic range.

In a fifth aspect, a computerized apparatus is disclosed. In one embodiment, the computerized apparatus is configured to render a viewport position in a source dynamic range and includes a memory configured to store imaging data associated with panoramic content; a processor apparatus in data communication with the memory; and computerized logic, that when executed by the processor apparatus, is configured to: receive the imaging data associated with panoramic content in a source dynamic range; receive a viewport position associated with at least a portion of the received imaging data; and render the imaging data associated with the panoramic content in the viewport position in the source dynamic range in order to produce a rendered source dynamic range image for the viewport position. The rendered source dynamic range image for the viewport position is configured to be developed into a display dynamic range image for display on a display device.

In one variant, the computerized apparatus includes an image capturing apparatus, the image capturing apparatus including two or more imaging sensors that are configured to capture respective differing fields of view.

In another variant, the computerized logic is further configured to: determine whether the received viewport position is resident on a stitching line for the panoramic content, and if so, stitch at least a portion of the stored imaging data in the received viewport position.

In yet another variant, the imaging data associated with panoramic content in the source dynamic range comprises a first dynamic range and the imaging data associated with the panoramic content in the viewport position in the source dynamic range comprises a second dynamic range, the second dynamic range being smaller than the first dynamic range. The rendered source dynamic range image for the viewport position takes into consideration the second dynamic range without taking into consideration the first dynamic range.

In yet another variant the computerized logic is further configured to: develop the rendered source dynamic range image into a display dynamic range image for the viewport position; encode the display dynamic range image for the viewport position; and transmit the encoded display dynamic range image for the purpose of the display on the display device.

In yet another variant, the computerized logic is further configured to: encode the rendered source dynamic range image for the viewport position; and transmit the encoded rendered source dynamic range image for the viewport position.

In another embodiment, the computerized logic is further configured to: obtain two or more images in a source dynamic range; stitch the obtained images in the source dynamic range; and render the panoramic image in the source dynamic range.

In yet another embodiment, the computerized logic is further configured to: obtain panoramic content in a source dynamic range; receive a viewport position for a viewer of the obtained images; render the viewport in the source dynamic range; develop/encode the viewport in a display dynamic range; and display the viewport in the display dynamic range.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1A is a graphical representation of one exemplary camera system including six (6) cameras useful in conjunction with the various aspects disclosed herein.

FIG. 1B is a graphical representation of one exemplary camera system including two (2) fisheye cameras useful in conjunction with the various aspects disclosed herein.

FIG. 2 is a logical block diagram of one exemplary apparatus for performing some of the methodologies disclosed herein.

FIG. 3 is a graphical representation of various projections of the panoramic content captured using the exemplary camera systems of FIG. 1A and FIG. 1B.

FIG. 4 is a graphical representation of various viewport positions within a panoramic image captured using, for example, the exemplary camera systems of FIG. 1B.

FIG. 5A is a logical flow diagram of one exemplary method for the display of a viewport in a display dynamic range using two or more images obtained in a source dynamic range in accordance with various aspects disclosed herein.

FIG. 5B is a logical flow diagram of another exemplary method for the display of a viewport in a display dynamic range using two or more images obtained in a source dynamic range in accordance with various aspects disclosed herein.

FIG. 6A is a logical flow diagram of yet another exemplary method for the display of a viewport in a display dynamic range using two or more images obtained in a source dynamic range and a received viewport position in accordance with various aspects disclosed herein.

FIG. 6B is a logical flow diagram of yet another exemplary method for the display of a viewport in a display dynamic range using two or more images obtained in a source dynamic range and a received viewport position in accordance with various aspects disclosed herein.

FIG. 7 is a logical flow diagram of an exemplary method for the rendering of a panoramic image in a source dynamic range, in accordance with various aspects disclosed herein.

FIG. 8 is a logical flow diagram of yet another exemplary method for the display of a viewport in a display dynamic range using a panoramic image obtained in a source dynamic range, such as for example, via the methodology described with reference to FIG. 7, in accordance with various aspects disclosed herein.

All Figures disclosed herein are © Copyright 2017 GoPro Inc. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation or implementation, but other implementations are possible by way of interchange of, or combination with, some or all of the described or illustrated elements. Wherever convenient, the same reference numbers will be used throughout the drawings to refer to same or like parts.

### Apparatus

As a brief aside, panoramic content (e.g., content captured using 180°, 360° and/or other fields of view (FOV)) and/or virtual reality (VR) content, may be characterized by high image resolution and/or high bit rates. Various resolution formats that are commonly used include e.g., 7680×3840 (also referred to as “8K” with a 2:1 aspect ratio), 7680×4320 (8K with a 16:9 aspect ratio), 3840×1920 (also referred to as “4K” with a 2:1 aspect ratio), and 3840×2160 (4K with a 16:9 aspect ratio). Existing bit rates can exceed fifty (50) megabits per second (Mbps). In some cases, panoramic content may be created by stitching together multiple images; in other cases, panoramic content may be generated according to e.g., computer modeling, etc. Similarly, VR content and VR-like content may be dynamically generated based at least in part on computer models and user viewing input (e.g., head tilt and motion parameters, such as pitch, yaw, and roll).

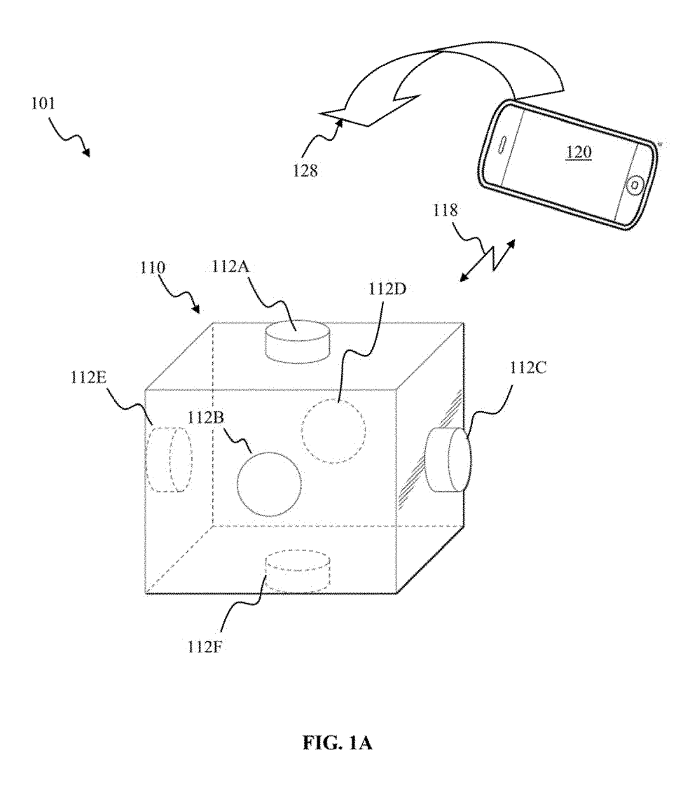

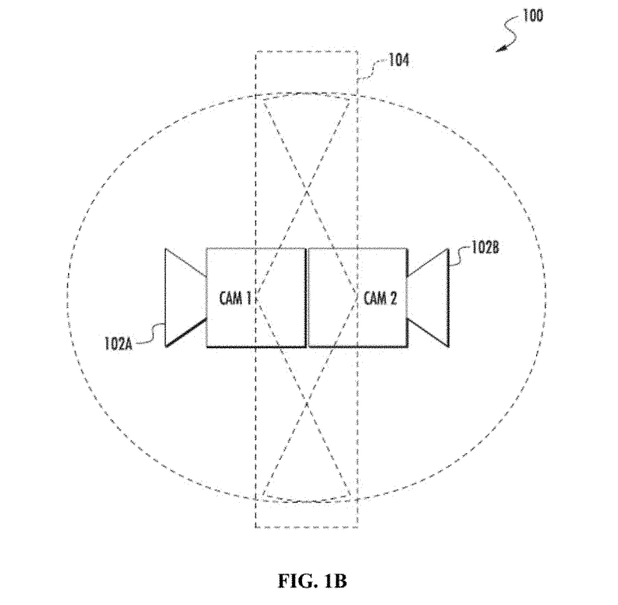

For example, FIG. 1A illustrates one exemplary camera system 101 that includes a six (6) camera image capture device 110 as well as a computing device 120 that is configured to receive the captured images/video via a wireless (or wired) communication link 118. The image capture device 110 includes six (6) cameras (112A, 112B, 112C, 112D, 112E, 112F) that are mounted according to a cube chassis. The greater number of cameras allows for less distortive lens effects (i.e., the source images may be anywhere from 90° to 120° FOV and rectilinear as opposed to wider spherical formats). The six (6) source images captured using the image capture device 110 of FIG. 1A may be stitched together to obtain images with, for example, a 360° FOV. The stitched image(s) may be rendered in an equirectangular projection (ERP), cubic projection and/or other suitable projections for display on, for example, computing device 120. For example, the stitching methodologies described in co-owned and co-pending U.S. patent application Ser. No. 15/289,851 filed Oct. 10, 2016 and entitled “Apparatus and Methods for the Optimal Stitch Zone Calculation of a Generated Projection of a Spherical Image”, the contents of the foregoing being incorporated herein by reference in its entirety, may be utilized in order to stitch the obtained images. As a user of computing device 120 traverses an arc 128 through space, the images displayed on computing device 120 may alternate between different FOVs captured by individual ones of the cameras (e.g., a display port traversing images captured using cameras 112D, 112A and 112B as but one example).

Other panoramic imaging formats may use a greater or fewer number of cameras along any number of viewing axes to support a variety of FOVs (e.g., 120°, 180°, 270°, 360° and other FOVs). For example, a four (4) camera system may provide a 360° horizontal panorama with a 120° vertical range. Under certain conditions, a single camera may be used to catch multiple images at different views and times; these images can be stitched together to emulate a much wider FOV image. Still other camera rig configurations may use multiple cameras with varying degrees of overlapping FOV, so as to achieve other desirable effects (e.g., better reproduction quality, three dimensional (3D) stereoscopic viewing, etc.).

Panoramic content can be viewed on a normal or widescreen display; movement within the panoramic image can be simulated by “panning” through the content (horizontally, vertically, or some combination thereof), zooming into and out of the panorama, and in some cases stretching, warping, or otherwise distorting the panoramic image so as to give the illusion of a changing perspective and/or field of view. One such example of “warping” a viewing perspective is the so-called “little world” projection (which twists a rectilinear panorama into a polar coordinate system; creating a “little world”). Common applications for viewing panoramic content include without limitation: video games, geographical survey, computer aided design (CAD), and medical imaging. More recently, advances in consumer electronics devices have enabled varying degrees of hybrid realities, ranging on a continuum from complete virtual reality to e.g., augmented reality, mixed reality, mixed virtuality, and other immersive forms of viewing content.

FIG. 1B depicts another exemplary camera system 100 that includes two (2) spherical (or “fish eye”) cameras (102A, 102B) that are mounted in a back-to-back configuration (also commonly referred to as a “Janus” configuration). As used herein, the term “camera” includes, without limitation, sensors capable of receiving electromagnetic radiation, whether in the visible band or otherwise (e.g., IR, UV), and producing image or other data relating thereto. The two (2) source images in this example have a 180° or greater FOV; the resulting images may be stitched along a median 104 between the images to obtain a panoramic image with a 360° FOV. The “median” in this case refers to the overlapping image data captured using the two (2) cameras 102A, 102B. Stitching is necessary to reconcile the differences introduced based on e.g., lighting (e.g., differences between the lighting captured between the two (2) cameras 102A, 102B), focus, positioning, lens distortions, color, and/or other considerations. Stitching may stretch, shrink, replace, average, and/or reconstruct imaging data as a function of the input images. Janus camera systems are described in e.g., U.S. Design patent application Ser. No. 29/548,661, entitled “MULTI-LENS CAMERA” filed on Dec. 15, 2015, and U.S. patent application Ser. No. 15/057,896, entitled “UNIBODY DUAL-LENS MOUNT FOR A SPHERICAL CAMERA” filed on Mar. 1, 2016, which is incorporated herein by reference in its entirety.

Extant camera systems (such as image capture device 100 and image capture device 110) typically capture panoramic images in a RAW image file format. As a brief aside, so-called RAW image files contain minimally processed data originating from the imaging sensor(s) of, for example, the aforementioned camera systems. Camera systems typically have fixed capture capabilities and must dynamically adjust its camera sensor functionality so as to compensate for, e.g., exposure setting(s), white balance setting(s) and the like. RAW image files are typically 12-bit or 14-bit data that is indicative of the full color space of the original capture device and further includes captured metadata (e.g., exposure settings). RAW image formats are typically implementation and capture-specific and are not always suitable for use across other devices. During conversion, the RAW imaging data may be quantized down to, for example, 8/10-bit RGB/YCrCb values and/or otherwise converted to a common or otherwise standard file format (e.g., JPEG/MPEG and the like).

Moreover, the so-called dynamic range of an image corresponds to the range of luminosity/color space over the image field. The dynamic range of a captured image may be limited by the camera sensor's capability, display capability, and/or other considerations. Additionally, the dynamic range of an image can be improved by e.g., various image post-processing techniques. For example, combining multiple standard dynamic range images at different exposure times can create a higher dynamic range image (e.g., data from the long exposure may capture under lit objects, while data from the short exposure may compensate for very bright objects). One such technique for improving upon the dynamic range of captured image(s) is referred to as so-called high dynamic range (HDR) imaging. As a brief aside, HDR imaging reproduces images/video with a greater dynamic range of luminosity so as to, inter alfa, reproduce captured images in a manner similar to that experienced through the human visual system.

Prior to displaying these captured images on display devices such as, e.g., computing device 120, the RAW file data goes through post-processing methodologies such as image compression, white balance, color saturation, contrast, sharpness and the like. Moreover, as a result of these post-processing methodologies (e.g., image compression), the size of these data files is reduced (e.g., from 12/14-bit data to 8-bit data), where they are reproduced into a so-called display dynamic range (e.g., standard dynamic range (SDR)). Source dynamic range images have numerous advantages over display dynamic range images including: higher image quality; an increased number of available shades of color (e.g., 4096-16384 shades of color in HDR versus 256 shades of color in SDR); easier data manipulation (e.g., for setting color space parameters); non-destructive data manipulation (e.g., image manipulation is performed with metadata leaving the original data unchanged); and reduced/eliminated quantization and compression-type artifacts. However, source dynamic range images may have drawbacks over display dynamic range images including, for example, image file size (e.g., HDR files may have 2-6 times the file size of an SDR file) and lack of widespread adoption of a standardized file format.

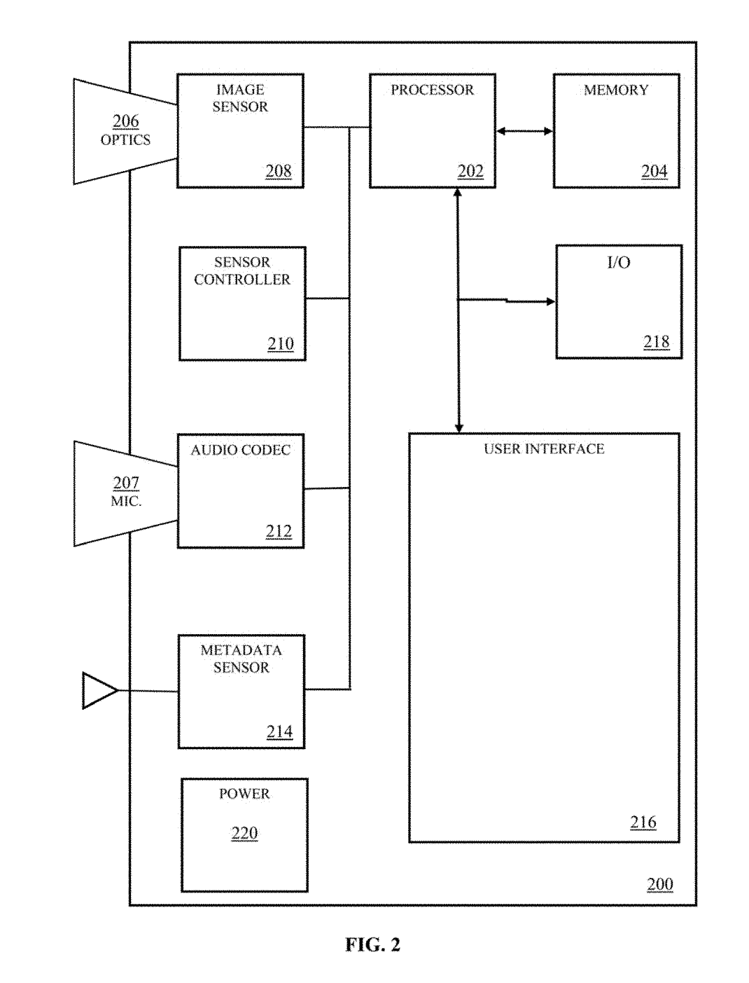

FIG. 2 illustrates one generalized implementation of an apparatus 200 for encoding and/or decoding of imaging content of interest based on the aforementioned source dynamic range (e.g., HDR) and display dynamic range (e.g., SDR) images. The apparatus 200 of FIG. 2 may include one or more processors 202 (such as system on a chip (SOC), microcontroller, microprocessor, central processing unit (CPU), digital signal processor (DSP), application specific integrated circuit (ASIC), general processing unit (GPU), and/or other processors) that control the operation and functionality of the apparatus 200. In some implementations, the apparatus 200 may correspond to a VR head set or a consumer electronics device (e.g., a smart phone, tablet, PC, etc.) configured to capture, store, and/or render VR and VR-like content.

The apparatus 200 may include electronic storage 204. The electronic storage 204 may include a non-transitory system memory module that is configured to store executable computer instructions that, when executed by the processor(s) 202, perform various device functionalities including those described herein. The electronic storage 204 may also include storage memory configured to store content (e.g., metadata, images, audio) captured by, for example, the apparatus 200 and/or other external camera apparatus.

In one such exemplary embodiment, the electronic storage 204 may include non-transitory memory configured to store configuration information and/or processing code to capture, store, retrieve, and/or render, e.g., video information, metadata and/or to produce a multimedia stream including, e.g., a video track and metadata in accordance with the methodology of the present disclosure. In one or more implementations, the processing configuration may be further parameterized according to, without limitation: capture type (video, still images), image resolution, frame rate, burst setting, white balance, recording configuration (e.g., loop mode), audio track configuration, and/or other parameters that may be associated with audio, video and/or metadata capture. Additional memory may be available for other hardware/firmware/software needs of the apparatus 200. The processor(s) 202 may interface to the sensor controller module 210 in order to obtain and process sensory information for, e.g., object detection, face tracking, stereo vision, and/or other tasks.

The apparatus 200 may include an optics module 206. In one or more implementations, the optics module 206 may include, by way of non-limiting example, one or more of standard lens, macro lens, zoom lens, special-purpose lens, telephoto lens, prime lens, achromatic lens, apochromatic lens, process lens, wide-angle lens, ultra-wide-angle lens, fisheye lens, infrared lens, ultraviolet lens, perspective control lens, other lens, and/or other optics components. In some implementations, the optics module 206 may implement focus controller functionality configured to control the operation and configuration of the camera lens. The optics module 206 may receive light from an object and couple received light to an image sensor 208. The image sensor 208 may include, by way of non-limiting example, one or more of a charge-coupled device sensor, active pixel sensor, complementary metal-oxide semiconductor sensor, N-type metal-oxide-semiconductor sensor, and/or other image sensor. The image sensor 208 may be configured to capture light waves gathered by the optics module 206 and to produce image(s) data based on control signals from the sensor controller module 210 (described below). The optics module 208 may include a focus controller configured to control the operation and configuration of the lens. The image sensor may be configured to generate a first output signal conveying first visual information regarding the object. The visual information may include, by way of non-limiting example, one or more of an image, a video, and/or other visual information. The optical element 206, and the image sensor module 208 may be embodied in a housing.

In some implementations, the image sensor module 208 may include, without limitation, video sensors, audio sensors, capacitive sensors, radio sensors, accelerometers, vibrational sensors, ultrasonic sensors, infrared sensors, radar, LIDAR and/or sonars, and/or other sensory devices.

The apparatus 200 may include one or more audio components 212 including, e.g., microphone(s) 207 and/or speaker(s). The microphone(s) 207 may capture audio content information, while speakers may reproduce audio content information.

The apparatus 200 may include a sensor controller module 210. The sensor controller module 210 may be used to operate the image sensor 208. The sensor controller module 210 may receive image or video input from the image sensor 208; audio information from one or more microphones, such as via audio component module 212. In some implementations, audio information may be encoded using audio coding format, e.g., AAC, AC3, MP3, linear PCM, MPEG-H and or other audio coding format (audio codec). In one or more implementations of “surround” based experiential capture, multi-dimensional audio may complement e.g., panoramic or spherical video; for example, the audio codec may include a stereo and/or 3-dimensional audio codec.

The apparatus 200 may include one or more metadata modules 214 embodied within the housing and/or disposed externally to the apparatus. The processor 202 may interface to the sensor controller 210 and/or one or more metadata modules. Each metadata module 214 may include sensors such as an inertial measurement unit (IMU) including one or more accelerometers and/or gyroscopes, a magnetometer, a compass, a global positioning system (GPS) sensor, an altimeter, ambient light sensor, temperature sensor, and/or other environmental sensors. The apparatus 200 may contain one or more other metadata/telemetry sources, e.g., image sensor parameters, battery monitor, storage parameters, and/or other information related to camera operation and/or capture of content. Each metadata module 214 may obtain information related to the environment of, for example, the capture device and an aspect in which the content is captured and/or to be rendered.

By way of a non-limiting example: (i) an accelerometer may provide device motion information, including velocity and/or acceleration vectors representative of motion of the apparatus 200; (ii) a gyroscope may provide orientation information describing the orientation of the apparatus 200; (iii) a GPS sensor may provide GPS coordinates, and time, that identify the location of the apparatus 200; and (iv) an altimeter may provide the altitude of the apparatus 200. In some implementations, the metadata module 214 may be rigidly coupled to the apparatus 200 housing such that any motion, orientation or change in location experienced by the apparatus 200 is also experienced by the metadata sensors 214. The sensor controller module 210 and/or processor 202 may be operable to synchronize various types of information received from the metadata sources 214. For example, timing information may be associated with the sensor data. Using the timing information, metadata information may be related to the content (photo/video) captured by the image sensor 208. In some implementations, the metadata capture may be decoupled from the video/image capture. That is, metadata may be stored before, after, and in-between one or more video clips and/or images that have been captured. In one or more implementations, the sensor controller module 210 and/or the processor 202 may perform operations on the received metadata to generate additional metadata information. For example, a microcontroller may integrate received acceleration information to determine a velocity profile of the apparatus 200 during the recording of a video. In some implementations, video information may consist of multiple frames of pixels using any applicable encoding method (e.g., H262, H.264, Cineform® and/or other standard).

Embodiments of either the camera systems and/or hybrid reality viewers may interface with external interfaces to provide external metadata (e.g., GPS receivers, cycling computers, metadata pucks, and/or other devices configured to provide information related to the device and/or its environment) via a remote link. The remote link may interface to an external user interface device. In some implementations, the remote user interface device may correspond to a smart phone, a tablet computer, a phablet, a smart watch, a portable computer, and/or other device configured to receive user input and communicate information. Common examples of wireless link interfaces include, without limitation, Wi-Fi, Bluetooth (BT), cellular data link, ZigBee, near field communications (NFC) link, ANT+ link, and/or other wireless communications links. Common examples of a wired interface include without limitation, HDMI, USB, DVI, DisplayPort, Ethernet, Thunderbolt, and/or other wired communications links.

The user interface device may operate a software application (e.g., GoPro Studio, GoPro App, and/or other software applications) configured to perform a variety of operations related to the camera configuration, control of video acquisition, and/or display of images/video. For example, some applications (e.g., GoPro App) may enable a user to create short video clips and share clips to a cloud service (e.g., Instagram, Facebook, YouTube, Dropbox); perform full remote control of the device, preview video being captured for shot framing, mark key moments while recording (e.g., with HiLight Tag), view key moments (e.g., View HiLight Tags in GoPro Camera Roll) based on location and/or playback of video highlights, control device software, and/or perform other functions.

The apparatus 200 may also include user interface (UI) module 216. The UI module 216 may include any type of device capable of registering inputs from and/or communicating outputs to a user. These may include, without limitation, display, touch, proximity sensitive interface, light, sound receiving/emitting devices, wired/wireless input devices and/or other devices. The UI module 216 may include a display, one or more tactile elements (e.g., buttons and/or virtual touch screen buttons), lights (light emitting diode (LED)), speaker, and/or other UI elements. The UI module 216 may be operable to receive user input and/or provide information to a user related to operation of the apparatus 200.

In one exemplary embodiment, the UI module 216 is a head mounted display (HMD). HMDs may also include one (monocular), two (binocular) or more display components which are mounted to a helmet, glasses, or other wearable article, such that the display component(s) are aligned to the user's eyes. In some cases, the HMD may also include one or more cameras, speakers, microphones, and/or tactile feedback (vibrators, rumble pads). Generally, HMD's are configured to provide an immersive user experience within a virtual reality, augmented reality, or modulated reality by reproducing a viewport within, for example, the captured panoramic content. So-called viewports are only representative of a portion of the captured panoramic content and are typically associated with the user's current “gaze”. For example, the currently displayed viewport may be based on user movements (e.g., head movements), or may be based on a virtual movement (e.g., controlled via the use of a mouse, or a pre-programmed tour). Various other wearable UI apparatuses (e.g., wrist mounted, shoulder mounted, hip mounted, etc.) would be readily appreciated by artisans of ordinary skill in the related arts given the contents of the present disclosure, the foregoing being purely illustrative.

The I/O interface module 218 of the apparatus 200 may include one or more connections to external computerized devices to allow for, inter alfa, content delivery and/or management of the apparatus 200. The connections may include wireless and/or wireline interfaces, and further may include customized or proprietary connections for specific applications. In some implementations, the I/O interface module 218 may include a component (e.g., a dongle), including an infrared sensor, a radio frequency antenna, ultrasonic transducer, and/or other communications interfaces. In one or more implementations, the I/O interface module 218 may include a local (e.g., Bluetooth, Wi-Fi) and/or broad range (e.g., cellular LTE) wireless communications interface configured to enable communications between the apparatus 200 and, for example, an external content source (e.g., a content delivery network).

The apparatus 200 may include a power system 220 that may be tailored to the needs of the application of the device. For example, for a small-sized lower power action camera, a wireless power solution (e.g. battery, solar cell, inductive (contactless) power source, and/or other power systems.) may be used.

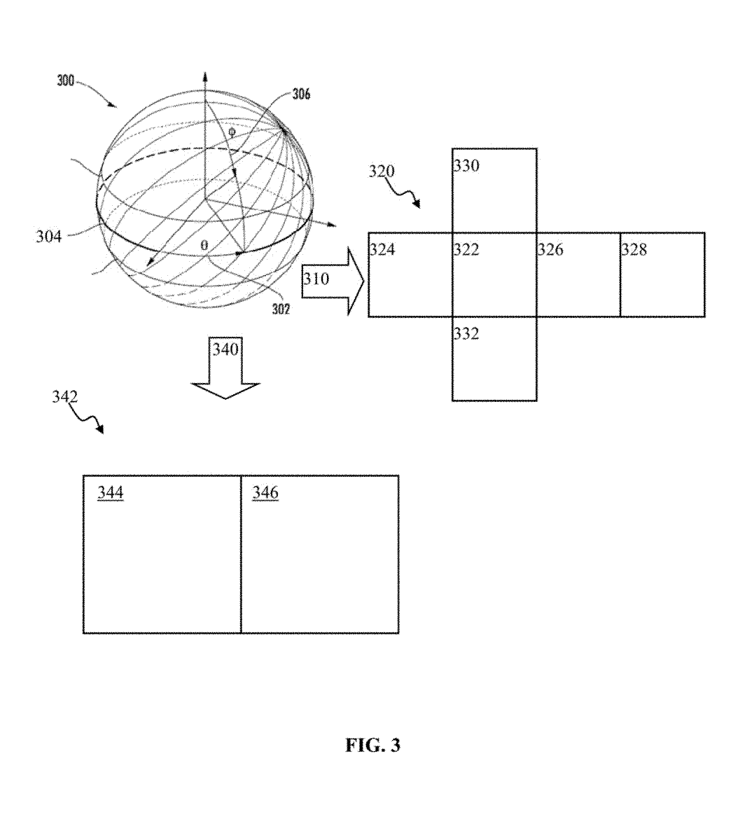

Referring now to FIG. 3, a spherical coordinate system 300 useful for characterizing images captured by the exemplary camera systems 110, 101 shown in FIGS. 1A and 1B is illustrated. Spherical angle θ, denoted by arrow 302 in FIG. 3 may be used to denote location of a pixel along the iso-line 304 in FIG. 3. Spherical angle θ, denoted by arrow 306 in FIG. 3 may be used to denote a location away from the equator 304. It will be appreciated that while the exemplary implementation(s) described herein are discussed in terms of a spherical coordinate system, other coordinate systems may be utilized consistent with the disclosure for certain functions including, without limitation, Cartesian, polar, and cylindrical coordinate systems.

For example, and with reference to FIG. 1A, a representation 310 of the spherical environment may be mapped into the collective output of images 320 captured by cameras 112A, 112B, 112C, 112D, 112E, 112F. Specifically, each facet 322, 324, 326, 328, 330, 332 shown in the collective output of images 320 may correspond to individual ones of the cameras 112A, 112B, 112C, 112D, 112E, 112F illustrated in FIG. 1A. For example, and by way of an illustration, the output of forward looking camera 112B may be assigned to facet 322, the output of upward looking camera 112A may be assigned to facet 330, the output of downward looking camera 112F may be assigned to facet 332, while the output of the other cameras of the apparatus 110 may be assigned to respective facets 324, 326, 328. Similarly, and with reference to FIG. 1B, a representation 340 of the spherical environment may be mapped into the collective output of images 342 captured by cameras 102A, 102B. For example, and by way of an illustration, the output of forward looking camera 102A may be assigned to facet 344, while the output of rearward facing camera 102 may be assigned to facet 346.

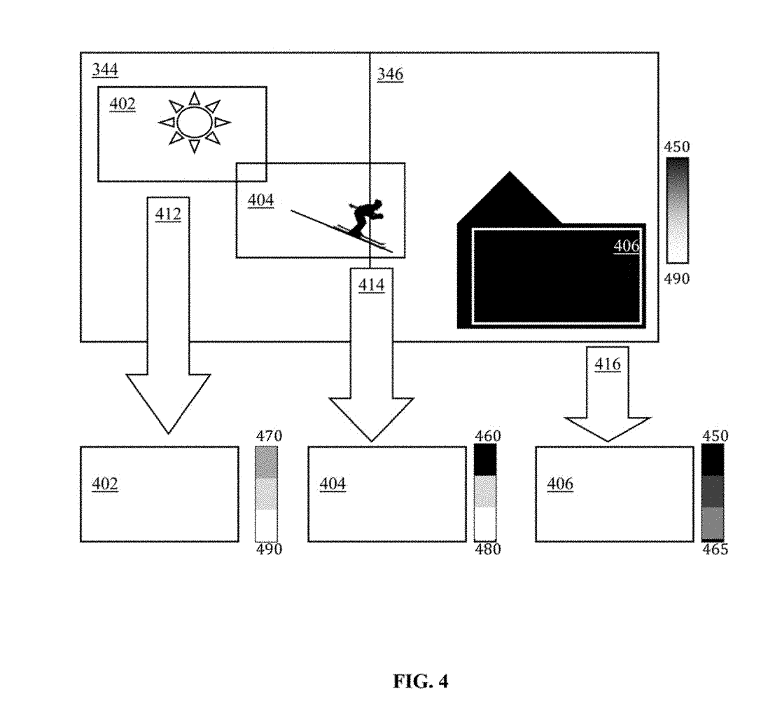

FIG. 4 illustrates various view port locations 402, 404, 406 associated with, for example, facets 344, 346. While the use of image facets 344, 346 is illustrative, it would be appreciated by one of ordinary skill given the contents of the present disclosure that other configurations may be used including, for example, representation 310 illustrated in FIG. 3. The collective output 342 of the combined images generated by, for example, camera system 100 may have a source dynamic range from high intensity (bright) areas 490 to lower intensity (dark) areas 450. For example, view port 402 may reside in a higher intensity area of the image (e.g., that includes direct sunlight) and hence may have a source dynamic range that varies from an intensity of 470 to an intensity 490 for this particular viewport location. Of particular note, is that view port 402 resides entirely within image facet 344. View port 406 may reside in a lower intensity area of the image (e.g., that resides within shadows) and hence may have a source dynamic range that varies from an intensity level 450 to an intensity level 465. View port 406 resides entirely within image facet 346. View port 404 may reside in a moderate intensity area of the image (e.g., in an area that neither is in direct sunlight, nor within the shadows) and hence may have a source dynamic range that varies from an intensity level 460 to an intensity level 480.

As a brief aside, the representation illustrated in FIG. 4 is illustrative of, in at least some implementations, one particular problem the present disclosure is intended to resolve. Namely, prior implementations would take into consideration the entirety of the source dynamic range of the combined images (i.e., from intensity level 450 to intensity level 490), when rendering individual ones of the viewports into a display dynamic range. As a result of the loss in fidelity between the conversion between source dynamic range images and display dynamic range images, using the entirety of the source dynamic range of the combined images may be sub-optimal.

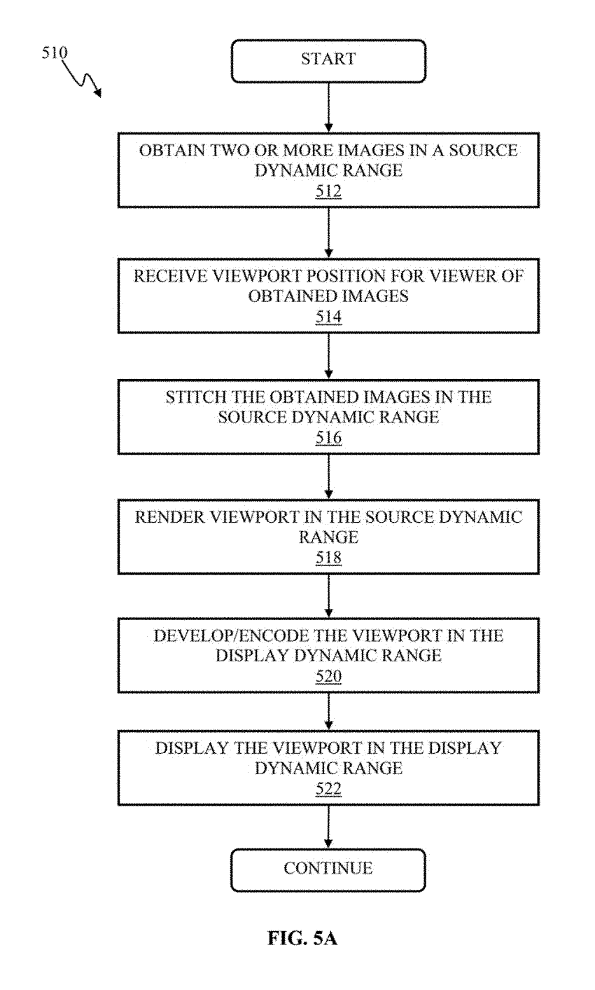

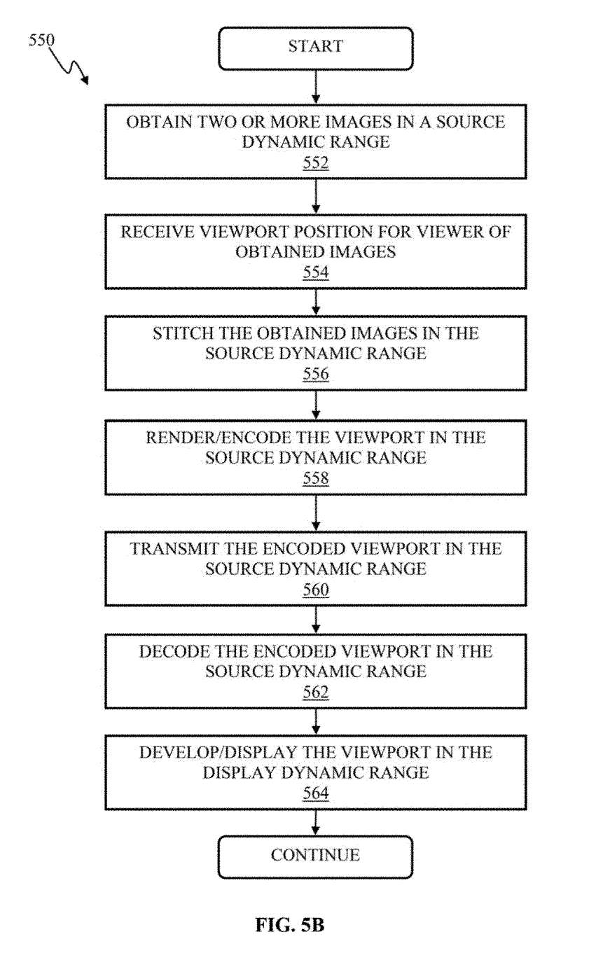

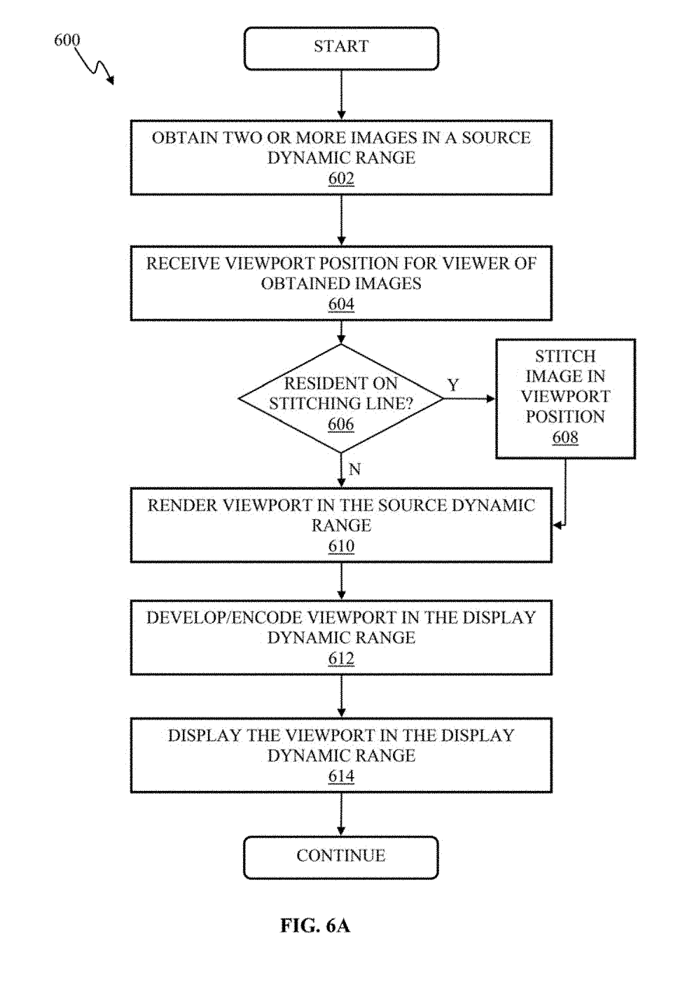

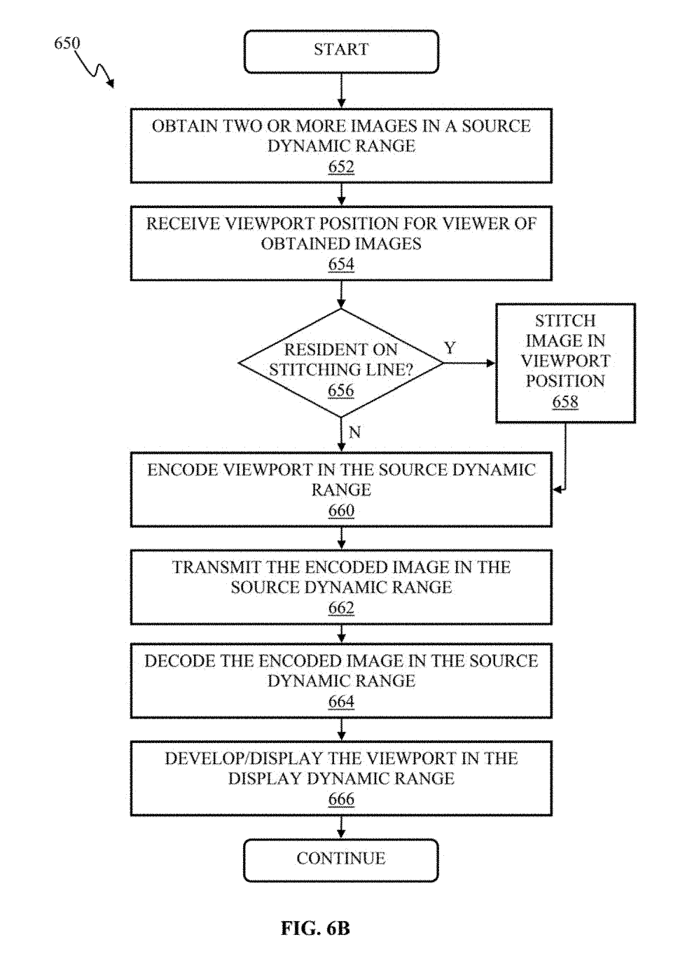

For example, implementations of the present disclosure may instead focus on the intensity ranges of individual viewport positions (e.g., viewport 402 ranging from an intensity level 470 to an intensity level 490) rather than taking into consideration the full intensity levels of the entirety of the captured images (intensity level 450 to intensity level 490). By taking into consideration the relevant intensity levels of the displayed viewport (as opposed to the intensity levels of the entire captured panoramic imaging data), higher quality and more life-like representations of the rendered viewport may be generated when converting between source dynamic range and display dynamic range imaging data. Moreover, in some implementations only the rendered viewport may be tone-mapped (as opposed to the tone-mapping of the entirety of the captured content), resulting in a better preservation of the dynamic range (and colors) for the rendered viewport. Additionally, the methodologies described herein may result in fewer processing resources being required as, for example, tone mapping of the entire panoramic imaging content when rendering the viewport would no longer be necessary. Reference to FIG. 4 will be made subsequently herein with regards to the discussion of the methodologies described in FIGS. 5A-6B.

### Methods

While the following discussions are presented primarily within the context of panoramic and VR content, artisans of ordinary skill in the related arts, given the contents of the present disclosure, will readily appreciate that the various aspects described herein may be utilized in other applications that would benefit from the selective viewing/processing of portions of an image or other sensor data. For example, and in one exemplary aspect, the following methods describe storing and retrieving portions of image data according to, inter alfa, location coordinates (e.g., viewport position) and dynamic range information. As previously noted, such applications may include, but are not limited to, gaming, medical, industrial, space/aeronautical, and geophysical exploration applications.

As but one particular example, magnetic resonance imaging (MRI) data can provide a 3D model of a human body, of which 2D slices or 3D representations may be selectively rendered. Similar applications may be used with computer aided design (CAD) and geophysical mappings to e.g., zoom-in/out of an image, produce wireframe models, vary translucency in visualizations, and/or dynamically cut-away layers of visualizations, etc. Likewise, multi-sensor “fused” data systems (such as the Rockwell Collins F-35 JSF Helmet Mounted Display, which permits the pilot to “look” through the airframe of the aircraft) can benefit from the various features disclosed herein (e.g., to optimize the rendering of the display based on considerations such as bright areas (looking towards the sun)/dark areas (areas shaded by the aircraft), etc.).

Referring now to FIG. 5A, one exemplary methodology 510 for the display of a viewport in a display dynamic range using two or more images obtained in a source dynamic range, in accordance with some implementations is illustrated. At operation 512, two or more images (content) are obtained in a source dynamic range (e.g., HDR). As described elsewhere herein, source dynamic range images have numerous advantages over display dynamic range images including higher image quality, an increased number of shades of color, easier data manipulation, ability for non-destructive data manipulation, and reduced/eliminated quantization and compression artifacts. However, source dynamic range images may have drawbacks over display dynamic ranges including, for example, image file size and lack of widespread adoption of a standardized file format for transmission/reception. The source dynamic range images may be obtained using, for example, the exemplary camera systems illustrated in FIGS. 1A and 1B. In some implementations, the two or more source dynamic range images may be obtained from a computer readable apparatus (e.g., a hard drive and/or other types of memory sources) from, for example, previously captured images.

At operation 514, a viewport position for a viewer of the content may be transmitted/received. For example, and referring back to FIG. 4, a viewport position indicative of one or more of viewports 402, 404 and 406 is received for the obtained images.

At operation 516, the obtained images from operation 512 may be stitched in order to obtain a stitched image in the source dynamic range. Source dynamic range stitching improves upon the stitching processing associated with display dynamic range images as there is much more information with regard to the capture conditions of the obtained images. For example, for depth-based stitching, since object recognition is generally based on feature detection, stitching algorithms could additionally reconcile the two images by backing out the pixel value differences that are caused by different exposure settings. As but another example, for simple stitching that is based on a cut-feather approach, the stitching algorithm can pre-adjust one or both images so that they are “apples-to-apples” images when stitching (e.g., a picture with a +2 exposure and a picture with −2 exposure may both be pre-filtered back to ‘0’ before the stitching process begins). It should be noted that this pre-adjustment can be performed with very little processing effort. Additionally, stitching may be performed based on a desired projection, a desired application, user preference, and/or a desired stitching technique. Different stitching techniques may have different power consumption characteristics, memory requirements, and latencies associated with the stitching process. These various tradeoffs can be mixed/matched according to, for example, an application requirement.

At operation 518, a viewport may be rendered in accordance with the received viewport position in the source dynamic range stitched image. For example, rendering may be based on the display device limitations. Additionally, or alternatively, rendering may be based on network connectivity limitations (e.g., bandwidth requirements, latency requirements, and the like). Additionally, rendering may be based on the current application requirements and/or user aesthetic preferences (for example, some users' may want over/under exposure for aesthetic considerations). Moreover, rendering may take into consideration the fact that the content may ultimately be displayed on multiple differing devices (e.g., for broadcast scenarios where there are multiple end display devices). Additionally, rendering may include the buffering of additional information at the periphery (e.g., to allow for faster twitch-type applications and/or gaming-type applications).

Referring back to FIG. 4, a user of the viewport may be oriented in the direction of viewport 402 and hence viewport 402 may be rendered in the source dynamic range. As but yet another example, and referring again to FIG. 4, a user of the viewport may be oriented in the direction of viewport 404 which resides on a stitch boundary and hence, the stitched image from operation 516 may be rendered for viewport 404. Finally, and as yet another example and referring again to FIG. 4, a user of the viewport may be oriented in the direction of viewport 406, and hence viewport 406 may be rendered in the source dynamic range.

As a brief aside, source dynamic range images (e.g., HDR images) preserves more details in highlights and shadows of the obtained images, which enables, for example, more vibrant colors than what would typically be possible with display dynamic range images (e.g., SDR images). As a result, by rendering the viewport in a source dynamic range, the displayed viewport (operation 522) is rendered in a way that is closer in perception by a viewer of this content as would be perceived by a human eye when viewing the scene. Prior implementations would develop the obtained source dynamic range images to, for example, a display dynamic range prior to the stitching/rendering operation, which may be suboptimal as the entire dynamic range of the source dynamic range images would need to be mapped to the target display dynamic range.

Contrast with implementations of the present disclosure in which only the dynamic range of the viewport position (as opposed to the entire obtained image) would need to be taken into consideration when developing/encoding the viewport in the display dynamic range (operation 520). For example, and referring back to viewport 402 of FIG. 4, the development of the viewport 402 into the display dynamic range would only need to take into consideration the dynamic range of the viewport (from a range between intensity level 470 and intensity level 490, for example) as opposed to prior implementations in which the entire range of the obtained images (from a range between intensity level 450 and intensity level 490), when developing the viewport.

In some implementations, and referring to the aforementioned example, it may be desirable to render the source dynamic range of the viewport into the display dynamic range using a higher range of intensity level (e.g., from intensity level 460 to intensity level 490 for viewport 402), a lower range of intensity level (e.g., from intensity level 450 to intensity level 460 for viewport 406), or a combination of the foregoing higher and lower intensity levels. For example, in implementations in which a viewer of video content in, for example, FIG. 4, one may contemplate a scenario in which a user “whip pans” from viewport position 402 (high intensity portion of image) to viewport position 406 (low intensity portion of image). In such a scenario, one may not necessarily want to fully adjust to the target dynamic range on a per-frame basis. While each frame of video content may look good with, for example, a sudden adjustment to the target dynamic range, such per-frame adjustment may appear artificial and not correlate with the behavior of a user's visual system (e.g., a user's eye can't look directly at the sun and then see clear shadow detail a split second later with a user's visual system).

Accordingly, in some implementations it may be desirable to include some hysteresis in the virtual re-exposing (e.g., HDR tone-mapping) of the image. In other words, and as but one example, viewport position 406 should appear very dark, immediately after viewing viewport position 402, then subsequently re-exposing gradually (e.g., after a second or two). Conversely, while whip panning from viewport position 406 to viewport position 402, viewport position 402 may appear overexposed (i.e., very bright) for a short duration before adjustment to a dynamic range that reveals image detail within viewport position 402 in some examples.

At operation 520, the developed viewport in the display dynamic range may be encoded for transmission. In some implementations, the developed viewport in the display dynamic range may allow for the reuse of existing codecs. As a result, existing infrastructure and applications may be reused as well. For example, existing compression standards such as, for example, the aforementioned JPEG and/or H.264/AVC may be utilized to encode the developed viewport in the display dynamic range. Additionally, as only the relevant viewport image is encoded, processing resources and/or required bandwidth for the transmission channel is minimized as only the viewport portion of the image is encoded for transmission as opposed to encoding the entire two or more images obtained at step 512.

At operation 522, the developed viewport in the display dynamic range is displayed. In one or more implementations, the encoded viewport in the display dynamic range is received at a computing device for display to, for example, a user of the display.

Referring now to FIG. 5B, another exemplary methodology 550 for the display of a viewport in a display dynamic range using two or more images obtained in a source dynamic range, in accordance with some implementations is illustrated. At operation 552, two or more images are obtained in a source dynamic range (e.g., HDR). The source dynamic range images may be obtained using, for example, the exemplary camera systems illustrated in FIGS. 1A and 1B. In some implementations, the two or more source dynamic range images may be obtained from a computer readable apparatus (e.g., a hard drive and/or other types of memory sources) that includes previously captured imaging/video content.

At operation 554, a viewport position for a viewer of the content may be transmitted/received. For example, and referring back to FIG. 4, a viewport position indicative of one or more of viewports 402, 404 and 406 is received for the obtained images.

At operation 556, the obtained images from operation 552 may be stitched in order to obtain a stitched image in the source dynamic range. The stitching considerations described supra, with regards to FIG. 5A may be utilized in accordance with some implementations.

At operation 558, the stitched image in the source dynamic range obtained from operation 556 may be rendered/encoded in the source dynamic range and the encoded stitched image in the source dynamic range may be transmitted at operation 560.

As a brief aside, while the processing resources and/or required bandwidth for transmission may be higher using the methodology of FIG. 5B as compared with the methodology of FIG. 5A, the methodology of FIG. 5B may have advantages as well. For example, the receiving computing device may have access to more resources and/or may have access to more flexible processing techniques for developing the viewport in the display dynamic range (operation 564). For example, in implementations in which the obtained two or more images in the source dynamic range are static (e.g., representative of an immersive static scene), it may be more efficient in terms of processing resources and the like to obtain the entire encoded stitched image in the source dynamic range. Contrast this with, for example, obtaining multiple encoded stitched images in a series of frames of video data. In such an example, the methodology of FIG. 5A may be more efficient in terms of processing resources and/or bandwidth requirements. These are but exemplary usage scenarios and it would be readily appreciated by one of ordinary skill given the contents of the present disclosure that one or both of the methodologies of FIGS. 5A and 5B may be interchangeably used with either the display of static (e.g., pictures) or dynamic (e.g., video) images.

At operation 562, the transmitted encoded stitched image in the source dynamic range may be decoded in the source dynamic range and the viewport may be developed and displayed in the display dynamic range at operation 562.

Referring now to FIG. 6A, yet another exemplary methodology 600 for the display of a viewport in a display dynamic range using two or more images obtained in a source dynamic range, in accordance with some implementations is illustrated. At operation 602, two or more images are obtained in a source dynamic range (e.g., HDR). As discussed elsewhere herein, the source dynamic range images may be obtained using, for example, the exemplary camera systems illustrated in FIGS. 1A and 1B. In some implementations, the two or more source dynamic range images may be obtained from a computer readable apparatus (e.g., a hard drive and/or other types of memory sources) from, for example, previously captured images.

At operation 604, a viewport position for a viewer of the content may be transmitted and received. For example, and referring back to FIG. 4, a viewport position indicative of one or more of viewports 402, 404 and 406 is received for the obtained images.

At operation 606, a determination is made as to whether the received viewport position is resident on a stitching line. For example, and referring back to FIG. 4, if the received viewport position is indicative of viewport 404, the methodology will advance to operation 608 where the viewport is stitched in accordance with the aforementioned methodologies and considerations as discussed previously herein. If on the other hand, the received viewport position is indicative of viewport 402, or viewport 406, the need to stitch will be deemed unnecessary and the methodology will advance to operation 610 from determination operation 606.

As a brief aside, if the determination operation 606 indicates that the received viewport is resident on the stitching line, the image is stitched at operation 608. In some implementations, the stitching may only occur within the displayed viewport (i.e., it may be unnecessary and/or undesirable to stitch the entire images obtained at operation 602). Accordingly, in this aforementioned situation processing resources may be minimized as a result of only stitching the two or more obtained images within the received viewport position. In some implementations, upon a determination that the received viewport position is resident on a stitching line, stitching operation 608 may be performed on the entirety of the obtained two or more images. For example, in situations such as the aforementioned static scene, it may be desirable to stitch the entire image as it may be determined that the likelihood that a subsequently received viewport position may also be resident on the stitching line, albeit it may be in a different position than the previously mentioned viewport position.

At operation 610, the viewport is rendered in the source dynamic range. For example, rendering may be based on the display device limitations. Additionally, or alternatively, rendering may be based on network connectivity limitations (e.g., bandwidth requirements, latency requirements, and the like). Additionally, rendering may be based on the current application requirements and/or user aesthetic preferences (for example, some users' may want over/under exposure for aesthetic considerations). Moreover, rendering may take into consideration the fact that the content may ultimately be displayed on multiple differing devices (e.g., for broadcast scenarios where there are multiple end display devices). Additionally, rendering may include the buffering of additional information at the periphery (e.g., to allow for faster twitch-type applications and/or gaming-type applications).

In one or more implementations, the dynamic range of the received viewport position is utilized in the rendering of the viewport at operation 610. For example, if the received viewport position is indicative of viewport position 406 in FIG. 4, the rendered viewport will only take into consideration the viewport dynamic range between intensity ranges 450 and 465, as opposed to taking into consideration the full dynamic range of the obtained images (i.e., between intensity ranges 450 and 490). Although primarily envisaged as only taking into consideration the dynamic range of the received viewport position, it would be readily appreciated by one of ordinary skill given the contents of the present disclosure that it may be desirable to take into consideration dynamic ranges outside (larger, smaller, or combinations of the foregoing) of the obtained images (i.e., ranges lying between intensity level 450 and intensity level 490 in FIG. 4). For example, referring to viewport position 402 where the imagery includes a bright source of light intensity (i.e., the sun), it may make sense to ignore the extremes of the intensity information in computing the target dynamic range. In other words, one may provide additional detail for the depicted viewport by focusing on the intensity information of the sky and clouds, while ignoring/minimizing the intensity information of the sun. Accordingly, one may use a spatially smaller region (or larger region) of the viewport for computing the target dynamic range of an image. In some implementations, it may be desirable too use a weighted sampling of a subset of the viewable image for the purposes of computing the target dynamic range of the image.

At operation 612, the rendered viewport in the source dynamic range is developed and encoded into a viewport having the display dynamic range. At operation 614, the viewport encoded into the display dynamic range is decoded and displayed to a viewer of the content.

Referring now to FIG. 6B, yet another exemplary methodology 650 for the display of a viewport in a display dynamic range using two or more images obtained in a source dynamic range, in accordance with some implementations is illustrated. At operation 652, two or more images are obtained in a source dynamic range (e.g., HDR). As discussed elsewhere herein, the source dynamic range images may be obtained using, for example, the exemplary camera systems illustrated in FIGS. 1A and 1B. In some implementations, the two or more source dynamic range images may be obtained from a computer readable apparatus (e.g., a hard drive and/or other types of memory sources) from, for example, previously captured images.

At operation 654, a viewport position for a viewer of the content will be transmitted and received. For example, and referring back to FIG. 4, a viewport position indicative of one or more of viewports 402, 404 and 406 is received for the obtained images.

At operation 656, a determination is made as to whether the received viewport position is resident on a stitching line. For example, and referring back to FIG. 4, if the received viewport position is indicative of viewport position 404, the methodology will advance to operation 658 where the viewport is stitched. If on the other hand, the received viewport position is indicative of, for example, viewport position 402, or viewport position 406, the need to stitch will be deemed unnecessary and the methodology will advance to operation 660 from determination operation 656.

In some implementations, where the determination operation 656 indicates that stitching is required, the stitching may only occur within the displayed viewport (i.e., it may be unnecessary and/or undesirable to stitch the entire images obtained at operation 652). Accordingly, in this aforementioned situation, processing resources may be minimized as a result of only stitching the two or more obtained images within the received viewport position. In some implementations, upon a determination that the received viewport position is resident on a stitching line, stitching operation 658 may be performed on the entirety of the obtained two or more images. For example, in situations such as the aforementioned static scene, it may be desirable to stitch the entire image as it may be determined that the likelihood that a subsequently received viewport position may also be resident on the stitching line, albeit it may be in a different position than the previously mentioned viewport position.

At operation 660, the received viewport position may be encoded in the source dynamic range. At operation 662, the encoded image is transmitted while in the source dynamic range and at operation 664, the encoded image is decoded in the source dynamic range. At operation 666, the decoded image in the source dynamic range is developed for display.

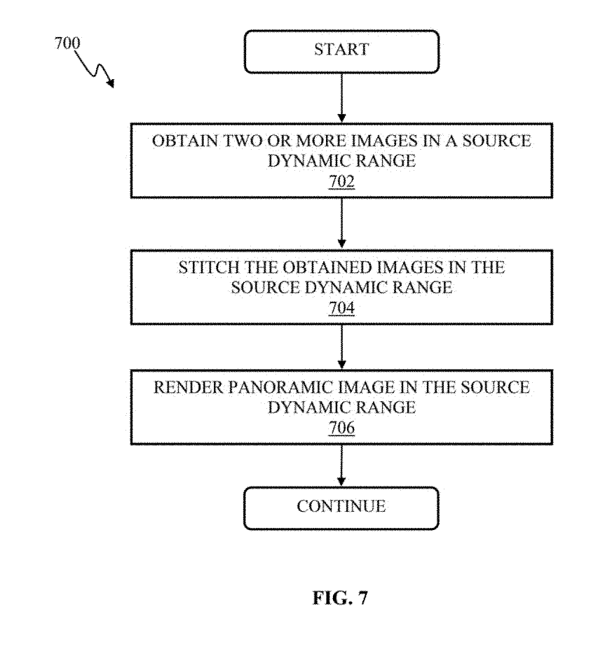

Referring now to FIG. 7, an exemplary methodology for the rendering of a panoramic image in a source dynamic range is illustrated in accordance with some implementations. At operation 702, two or more images are obtained in a source dynamic range (e.g., HDR). As discussed elsewhere herein, the source dynamic range images may be obtained using, for example, the exemplary camera systems illustrated in FIGS. 1A and 1B. In some implementations, the two or more source dynamic range images may be obtained from a computer readable apparatus (e.g., a hard drive and/or other types of memory sources) from, for example, previously captured images.

At operation 704, the obtained images from operation 702 may be stitched in order to obtain a stitched image in the source dynamic range. As described elsewhere herein, source dynamic range stitching improves upon the stitching processing associated with display dynamic range images as there is much more information with regard to the capture conditions for the obtained images. For example, for depth-based stitching, since object recognition is generally based on feature detection, stitching algorithms could additionally reconcile the two images by backing out the pixel value differences that are caused by different exposure settings. As but another example, for simple stitching that is based on a cut-feather approach, the stitching algorithm may pre-adjust one or both images when stitching (e.g., a picture with a +2 exposure and a picture with −2 exposure may both be pre-filtered back to ‘0’ before the stitching process begins). As previously discussed herein, it should be noted that this pre-adjustment may be performed with very little processing effort (minimal computation overhead, etc.). Additionally, stitching may be performed based on a desired projection, a desired application, a user preference, and/or a desired stitching technique. Different stitching techniques may have different power consumption characteristics, memory requirements, and latencies associated with the stitching process. These various tradeoffs can be mixed/matched according to, for example, a given application's requirement(s).

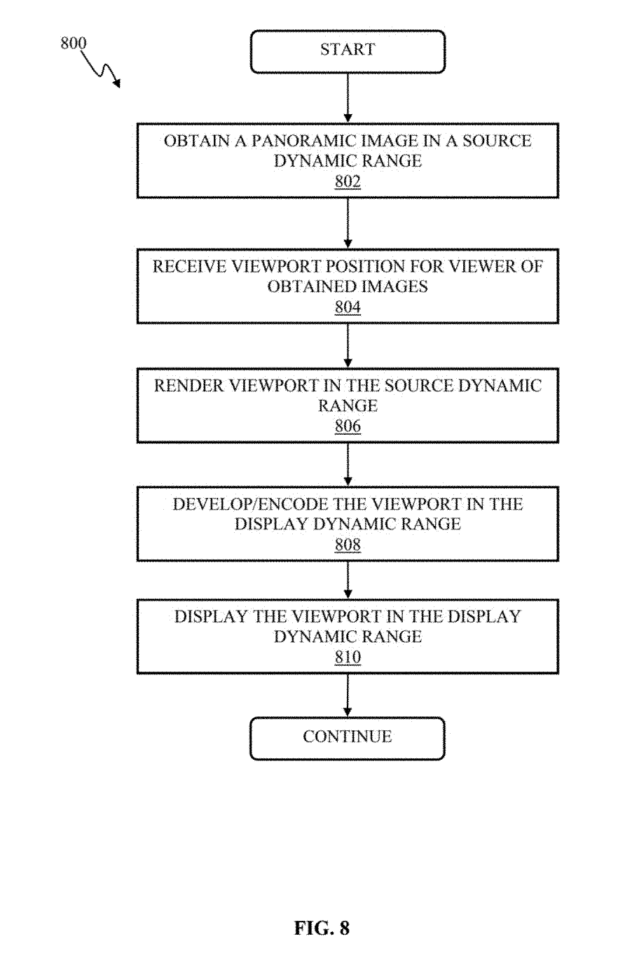

At operation 706, the panoramic image is rendered in the source dynamic range. In other words, rather than rendering a portion of the image in the source dynamic range (e.g., a viewport position) as described at, for example, operation 518 (FIG. 5A), operation 558 (FIG. 5B), and operation 610 (FIG. 6A), the entirety of the panoramic image is rendered in the source dynamic range. In some implementations, this rendered panoramic image in the source dynamic range may be encoded for transmission and/or may be stored for later retrieval/transmission and subsequent processing as described below with regards to FIG. 8.

Referring now to FIG. 8, an exemplary methodology 800 for displaying a viewport in a display dynamic range using an obtained panoramic image in a source dynamic range (such as that described with reference to FIG. 7) is shown. At operation 802, a panoramic image in a source dynamic range is obtained. In some implementations, this source dynamic range panoramic image may be retrieved from a computer readable apparatus (e.g., a hard disk drive, memory and the like), and/or may be received from a transmission.

At operation 804, a viewport position for a viewer of the obtained panoramic content in the source dynamic range will be transmitted and received. For example, and referring back to FIG. 4, a viewport position indicative of one or more of viewports 402, 404 and 406 is received for the obtained images.

At operation 806, the viewport is rendered in the source dynamic range. As discussed elsewhere herein, rendering may be based on, for example, the display device limitations. Additionally, or alternatively, rendering may be based on network connectivity limitations (e.g., bandwidth requirements, latency requirements, and the like). Additionally, rendering may be based on the current application requirements and/or user aesthetic preferences (for example, some users' may want over/under exposure for aesthetic considerations). Moreover, rendering may take into consideration the fact that the content may ultimately be displayed on multiple differing devices (e.g., for broadcast scenarios where there are multiple end display devices). Additionally, rendering may include the buffering of additional information at the periphery (e.g., to allow for faster twitch-type applications and/or gaming-type applications).

In one or more implementations, the dynamic range of the received viewport position (as opposed to the dynamic range of the entire panoramic image) is utilized in the rendering of the viewport at operation 806. For example, if the received viewport position is indicative of viewport position 406 in FIG. 4, the rendered viewport will only take into consideration the viewport dynamic range between intensity ranges 450 and 465, as opposed to taking into consideration the full dynamic range of the obtained images (i.e., between intensity ranges 450 and 490). Although primarily envisaged as only taking into consideration the dynamic range of the received viewport position, it would be readily appreciated by one of ordinary skill given the contents of the present disclosure that it may be desirable to take into consideration dynamic ranges outside (larger, smaller, or combinations of the foregoing) of the obtained images (i.e., ranges lying between intensity level 450 and intensity level 490 in FIG. 4). For example, referring to viewport position 402 where the imagery includes a bright source of light intensity (i.e., the sun), it may make sense to ignore the extremes of the intensity information in computing the target dynamic range. In other words, it may provide additional detail by focusing on the intensity information of the sky and clouds, while ignoring/minimizing the intensity information of the sun. Accordingly, one may use a spatially smaller region (or larger region) of the viewport for computing the target dynamic range of the image. In some implementations, it may be desirable too use a weighted sampling of a subset of the viewable image for the purposes of computing the target dynamic range of the image.

At operation 808, the viewport is developed/encoded in the display dynamic range. At operation 810, the viewport developed/encoded into the display dynamic range is decoded and/or displayed to a viewer of the content in the display dynamic range.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “content” refers generally to any audio/visual (AV) content including, without limitation, one or more of: images, video, audio, multimedia, etc.

As used herein, the terms “panoramic”, “fisheye”, and/or “spherical” refers generally to image content captured using 180°, 360°, and/or other wide format fields of view (FOV).

As used herein, the terms “rendering”, “reproducing”, and/or “displaying” refer generally to the playback and/or reproduction of content.

As used herein, the terms “virtual reality” (VR) content and/or “VR-like” content refer generally to content that is intended to be rendered with a movable field of view based on arbitrary user input (such as head movements), within a continuous and persistent artificial environment. VR content generally represents an immersive environment, whereas VR-like content may refer to “augmented reality”, “mixed reality”, “mixed virtuality”, “hybrid reality”, and/or any other content that is intended to be viewed to complement or substitute for the user's actual environment.

As used herein, the terms “computer”, “computing device”, and “computerized device”, include, but are not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

As used herein, the term “camera” may be used to refer to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A method for the display of imaging content, comprising:
obtaining two or more images in a source dynamic range;
receiving a viewport position for a viewer of at least a portion of the obtained two or more images;
determining whether the viewport position is resident on a stitching line, and if so, stitching at least a portion of the two or more images in the received viewport position;
rendering the viewport position in the source dynamic range in order to produce a rendered source dynamic range image for the viewport position;
developing the rendered source dynamic range image into a display dynamic range image for the viewport position;
encoding the display dynamic range image for the viewport position in a display dynamic range; and
transmitting the encoded display dynamic range image for the purpose of a display of the viewport position in the display dynamic range.

2. The method of claim 1, wherein the rendering of the viewport position in the source dynamic range is performed by utilizing a viewport dynamic range associated with the received viewport position without taking into consideration a full dynamic range associated with the two or more images.

3. The method of claim 2, wherein if it is determined that the received viewport position is not resident on the stitching line, obviating a stitching process for the transmitted encoded display dynamic range image.

4. The method of claim 2, further comprising:
receiving an updated viewport position for the viewer;
rendering the updated viewport position in the source dynamic range in order to produce an updated rendered source dynamic range image for the updated viewport position; and
developing the updated rendered source dynamic range image for the updated viewport position into an updated display dynamic range image for the updated viewport position.

5. The method of claim 4, further comprising:
determining whether the updated viewport position is resident on a stitching line, and if so, utilizing a stitching process for the updated viewport position.

6. The method of claim 5, wherein the stitching process is utilized only for the updated viewport position.

7. The method of claim 6, wherein the updated display dynamic range image for the updated viewport position is produced by utilizing the obtained two or more images in the source dynamic range.

8. The method of claim 6, wherein the updated display dynamic range image for the updated viewport position is produced by utilizing two or more other images in the source dynamic range.

9. A computer readable apparatus comprising a storage medium configured to store a computer program having a plurality of computer-executable instructions, the computer-executable instructions being configured to, when executed:
receive two or more images in a source dynamic range;
receive a viewport position for a viewer of at least a portion of the received two or more images; and
render the viewport position in the source dynamic range in order to produce a rendered source dynamic range image for the viewport position.

10. The computer readable apparatus of claim 9, further comprising computer-executable instructions that when executed are further configured to:
determine whether the viewport position is resident on a stitching line, and if so, stitch at least a portion of the two or more images in the received viewport position.

11. The computer readable apparatus of claim 9, further comprising computer-executable instructions that when executed are further configured to:
determine whether the viewport position is resident on a stitching line, and if not, obviate a stitching process for at least a portion of the two or more images in the received viewport position.

12. The computer readable apparatus of claim 9, further comprising computer-executable instructions that when executed are further configured to:
develop the rendered source dynamic range image into a display dynamic range image for the viewport position;
encode the display dynamic range image for the viewport position; and
transmit the encoded display dynamic range image for the purpose of a display of the viewport position in the display dynamic range.

13. The computer readable apparatus of claim 9, further comprising computer-executable instructions that when executed are further configured to:
encode the rendered source dynamic range image for the viewport position; and
transmit the encoded rendered source dynamic range image for the viewport position.

14. The computer readable apparatus of claim 13, wherein the transmitted encoded source dynamic range image for the viewport position is configured to be decoded by a computerized apparatus and developed into a display dynamic range image for display.

15. A computerized apparatus configured to render a viewport position in a source dynamic range, the computerized apparatus comprising:
a memory configured to store imaging data associated with panoramic content;
a processor apparatus in data communication with the memory; and
computerized logic, that when executed by the processor apparatus, is configured to:
receive the imaging data associated with panoramic content in a source dynamic range;
receive a viewport position associated with at least a portion of the received imaging data; and
render the imaging data associated with the panoramic content in the viewport position in the source dynamic range in order to produce a rendered source dynamic range image for the viewport position;
wherein the rendered source dynamic range image for the viewport position is configured to be developed into a display dynamic range image for display on a display device.

16. The computerized apparatus of claim 15, further comprising an image capturing apparatus, the image capturing apparatus comprising two or more imaging sensors that are configured to capture respective differing fields of view.

17. The computerized apparatus of claim 16, wherein the computerized logic is further configured to:
determine whether the received viewport position is resident on a stitching line for the panoramic content, and if so, stitch at least a portion of the stored imaging data in the received viewport position.

18. The computerized apparatus of claim 17, wherein the imaging data associated with panoramic content in the source dynamic range comprises a first dynamic range and the imaging data associated with the panoramic content in the viewport position in the source dynamic range comprises a second dynamic range, the second dynamic range being smaller than the first dynamic range;
wherein the rendered source dynamic range image for the viewport position takes into consideration the second dynamic range without taking into consideration the first dynamic range.

19. The computerized apparatus of claim 18, wherein the computerized logic is further configured to:
develop the rendered source dynamic range image into a display dynamic range image for the viewport position;
encode the display dynamic range image for the viewport position; and
transmit the encoded display dynamic range image for the purpose of the display on the display device.

20. The computerized apparatus of claim 18, wherein the computerized logic is further configured to:
encode the rendered source dynamic range image for the viewport position; and
transmit the encoded rendered source dynamic range image for the viewport position.
